(19) United States
(12) Patent Application Publication
(10) Pub. No.: US 2007/0013971 A1
(43) Pub. Date: Jan. 18, 2007

(54) Imaging System Utilizing Illumination and Optical Modules Contained within Rotating Optical Platens

(76) Inventor: Kurt Eugene Spears, La Jolla, CA (US)

Correspondence Address: HDSL, 4331 STEVENS BATTLE LANE, FAIRFAX, VA, 22033, US

(21) Appl. No.: 11/424,851

(22) Filed: Jun. 16, 2006

Related U.S. Application Data
(60) Provisional application No. 60/698,838, filed on Jul. 13, 2005.

(51) Int. Cl. H04N 1/04

(52) U.S. Cl. 358/474

(57) ABSTRACT

An imaging system includes an illumination system and an optical module which are used together to scan media. The illumination system is composed of a tubular diffusion platen, a light source, and a reflector. The optical module comprises a rotating optical platen that rotates around an imaging assembly composed of a lens array, an optical element, a linear sensor array, an interconnect circuit, and a housing. The optical platen is transparent to allow the imaging assembly to capture and image of the transparent media and functions to accurately locate the transparent media in the optimal focus plane.

### CROSS REFERENCE APPLICATIONS

This application claims priority from U.S. Provisional Patent Application No. 60/698,838, filed on Jul. 13, 2005.

### BACKGROUND OF THE INVENTION

1. Field of the Invention

The present invention relates to generally to the field of optics. More specifically, the present invention discloses a scanning assembly for acquiring images from reflective and transparent media.

2. Description of the Prior Art

The increasing proliferation of communication networks has increased consumer and business reliance on the fast receipt and transmittal of a variety of data, such as textual, graphic, and image information between devices such as computers, personal digital assistants (PDAs), cell phones, facsimile machines, and others. Many businesses have implemented systems where data is stored, transmitted, and received electronically, rather than in hard copy form. In many cases, it is more convenient to work with data in an electronic format so that, for example, the data may be transmitted as quickly as possible to a client, coworker, or other company as desired.

But many current scanning systems require significant size and power to provide high-quality reproductions of a hard copy document in an electronic form. For example, desktop scanners and multi-function peripherals require significant desktop area because they utilize flatbed scanning solutions. Such solutions require a flat platen glass that is at least as large as the document to be scanned. Other systems transport the document across a small optical surface to reduce the size of the flatbed platen, but these solutions require additional mechanical media handling and may require replaceable optical windows because the media passes over the optical window that can become damaged over time. In addition, fragile media can be damaged due to sliding across a fixed optical window.

Many compact scanner systems utilize gradient index (grin) lens arrays that have very short focal distances and very limited depth of focus. In these systems it is critical to properly locate the media in the correct focal plane to achieve acceptable image quality.

Therefore there is need for a compact scanning assembly for accurately and efficiently acquiring images from reflective and transparent media.

### SUMMARY OF THE INVENTION

To achieve these and other advantages and in order to overcome the disadvantages of the conventional method in accordance with the purpose of the invention as embodied and broadly described herein, the present invention provides an imaging system comprised of an optical module for generating a scanned image of a media object where the optical module utilizes a tubular platen that rotates about the scanning mechanism.

An object of the present invention is to provide an imaging system comprising an illumination system and an optical module which are used together to scan media. The illumination system is composed of a tubular diffusion platen, a light source, and a reflector. The optical module comprises a rotating optical platen that rotates around an imaging assembly composed of a lens array, an optical element, a linear sensor array, an interconnect circuit, and a housing. The optical platen is transparent to allow the imaging assembly to capture and image of the transparent media and functions to accurately locate the transparent media in the optimal focus plane.

Another object of the present invention is to provide an imaging system for capturing images of transparent media. An illumination system is positioned on one side of the transparent media and backlights the transparent media. The imaging system captures the image of the backlit media. A transparent optical platen rotates around the imaging system and positions the transparent media.

Another object of the present invention is to provide an imaging system where both the illumination and optical subsystems are contained within a single rotating optical platen. This imaging system is used for scanning opaque documents when the documents are illuminated from the same side as where the optical module is located.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a diagram illustrating an imaging system comprising an optical module according to an embodiment of the present invention;

FIG. 1B is a diagram illustrating an illumination pattern and optical path of the imaging system according to an embodiment of the present invention;

FIG. 1C is a diagram illustrating platen and media motion during a scan operation according to an embodiment of the present invention;

FIG. 2 is a diagram illustrating an imaging system comprising an optical module according to another embodiment of the present invention;

FIG. 3 is a diagram illustrating an imaging system comprising an optical module according to another embodiment of the present invention;

FIG. 4 is a diagram illustrating an imaging system comprising an optical module according to another embodiment of the present invention;

FIG. 5 is a diagram illustrating an imaging system comprising an optical module according to another embodiment of the present invention; and

FIG. 6 is a flowchart illustrating a method to scan a document according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

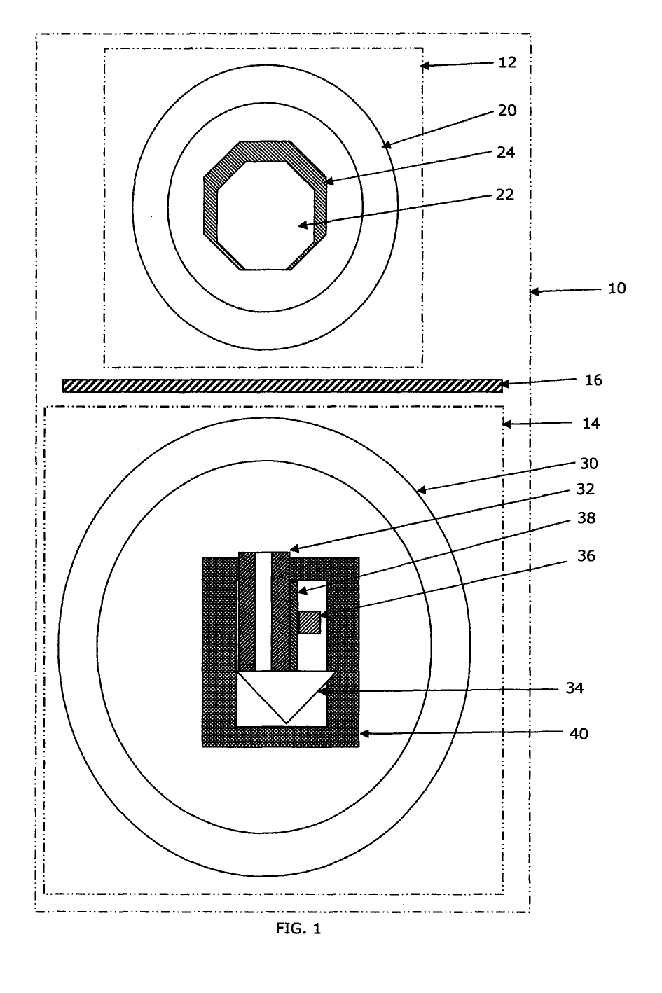

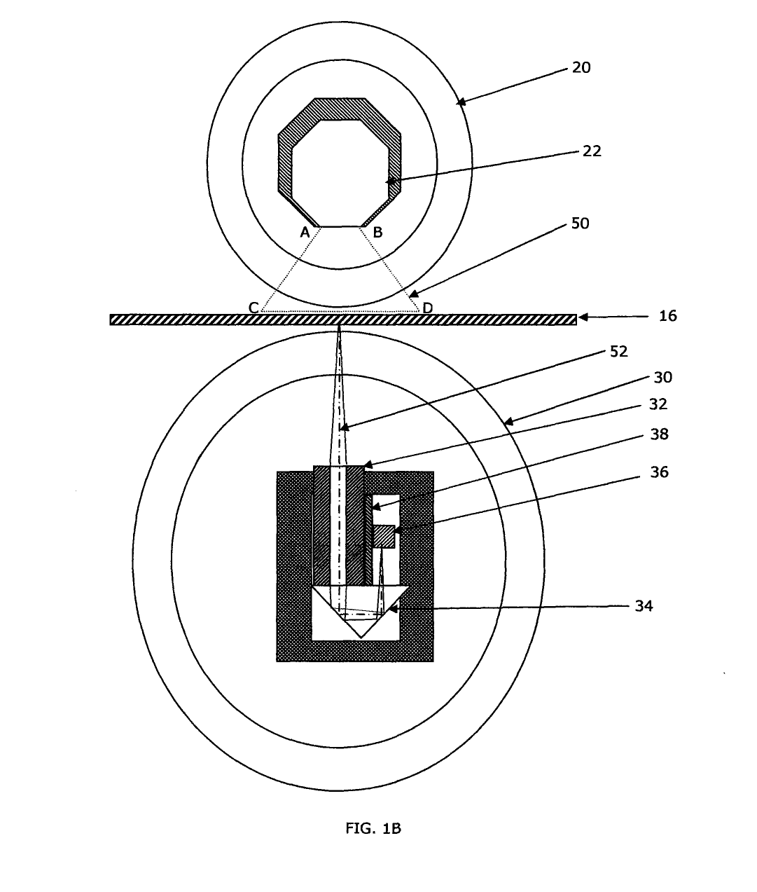

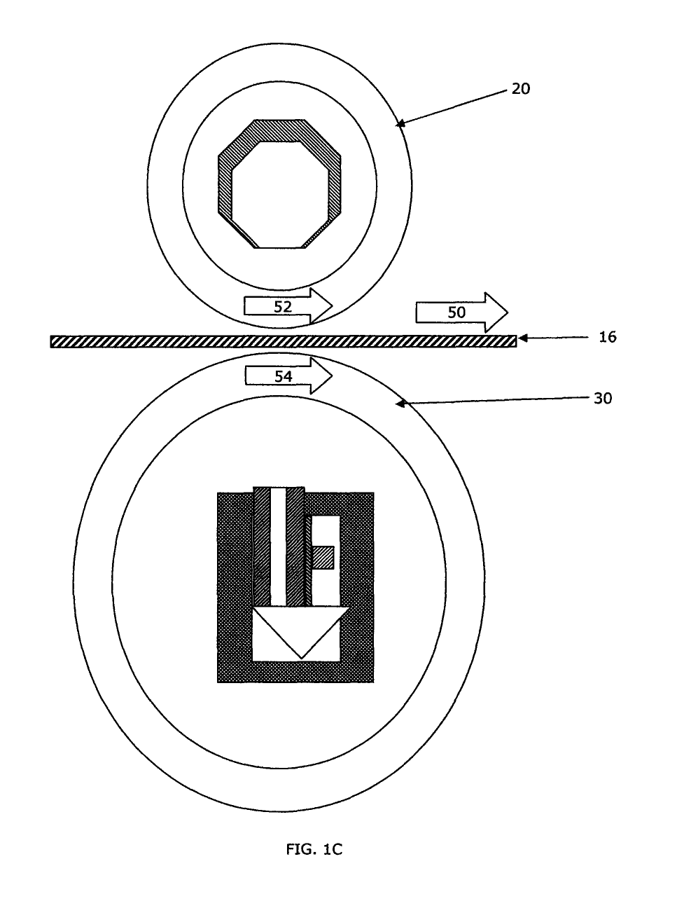

Refer to FIG. 1, which is a diagram illustrating a cross section of an imaging system 10 in which an embodiment of the present invention is used to advantage. The imaging system 10 is comprised of an illumination system 12 and an optical module 14 which are used together to scan transparent media 16.

The illumination system 12 is composed of three major pieces; a tubular diffusion platen 20, a light source 22, and a reflector 24. The tubular diffusion platen 20 is, for example, made from glass or plastic, and functions to diffuse the light from the light source 22 and functions to accurately locate the transparent media 16 in the optimal focus plane. The light source 22 is a controllable light that is white such as a fluorescent lamp or colored such as an LED illuminated light guide available from Nippon Sheet Glass or Pixon Corporation. The reflector 24 is a white or silvered reflector that reflects light toward the transparent media 16.

The optical module 14 consists of a rotating optical platen 30 that rotates around an imaging assembly comprised of a lens array 32, an optical element 34, a linear sensor array 36, an interconnect circuit 38, and a housing 40. The optical platen 30 is composed of optical plastic or glass and is transparent to allow the imaging assembly to capture an image of the transparent media 16 and functions to accurately locate transparent media 16 in the optimal focus plane. The lens array 32 is a unity magnification lens array such as the gradient index lens array available from Nippon Sheet Glass or Mitsubishi Rayon. These lens arrays utilize gradient index lenses to create an image of the transparent media 16 on the linear sensor array 36 after two reflections while passing through the optical element 34. The optical element 34 is utilized in folded optical path embodiments. In embodiments where a non-folded optical path is used, the optical element 34 is removed. The optical element 34 reduces the size of the imaging assembly and allows the rotating optical platen to be smaller. The optical element 34 comprises an optical prism or multiple mirrors mounted in the housing 40 and are designed according to various optical paths using one or more reflections. The linear sensor array 36 comprises a linear array of photosensitive sensors, also called pixels, constructed of Charge Coupled Device (CCD), Complimentary Metal Oxide Semiconductor (CMOS) technology or another photosensitive technology. Pixel elements in the linear sensor array 36 convert light into electrons that can be converted to an electrical voltage and digitized to provide digital data corresponding to the scan line on the transparent media 16. The interconnect circuit 38 is used to control and acquire the output signal from the linear sensor array 36. The housing 40 contains and aligns the components of the imaging assembly, isolates the components and optical path from ambient or stray light, provides structural integrity and interacts with external mechanical components to properly locate the optical assembly inside the rotating optical platen. The illumination system 12, the optical module 14 and the motion of the media 16, the diffusion platen 20 and rotating optical platen 30 are coordinated by a control system. This control system comprises electronics, firmware, software, electromechanical components, or a combination of these to interface the imaging system to external components or storage.

Refer to FIG. 1B, which shows a detailed cross section view of the illumination pattern of the illumination system 12 and the optical path of the optical module 14 relative to the transparent media 16. Polygon 50 depicts the illuminated space between the light source 22 and the transparent media 16. Light exits the light source 22 along line A-B and illuminates the transparent media 16 primarily along line C-D with peak illumination occurring at the middle of line C_D. Line 52 shows the centerline of the optical path from the object plane of the transparent media 16 to the image plane formed on the linear sensor array 36.

Refer to FIG. 1C, which illustrates the portions of the imaging system 10 that move during a scan operation. The transparent media 16 moves from left to right as shown by arrow 50. Simultaneously, the rotating diffusion platen 20 rotates counter-clockwise shown by arrow 52 and the rotating optical platen 30 moves clockwise as shown by arrow 54. In other embodiments of the present invention, the direction of travel is reversed. In these embodiments, the transparent media 16 moves in the opposite direction of arrow 50 while diffusion platen 20 rotates clockwise opposite of the direction indicated by arrow 52 and optical platen 30 moves counter-clockwise opposite of the direction indicated by arrow 54.

Refer to FIG. 2, which shows the cross section of an optical system in which an embodiment of the present invention is incorporated utilizing a non-folded optical path. The non-folded optical path is designated by optical path centerline 152. In this embodiment, light from the transparent media 16 passes through the rotating optical platen 30 and is captured and focused by the lens array 32 onto the linear sensor array 36.

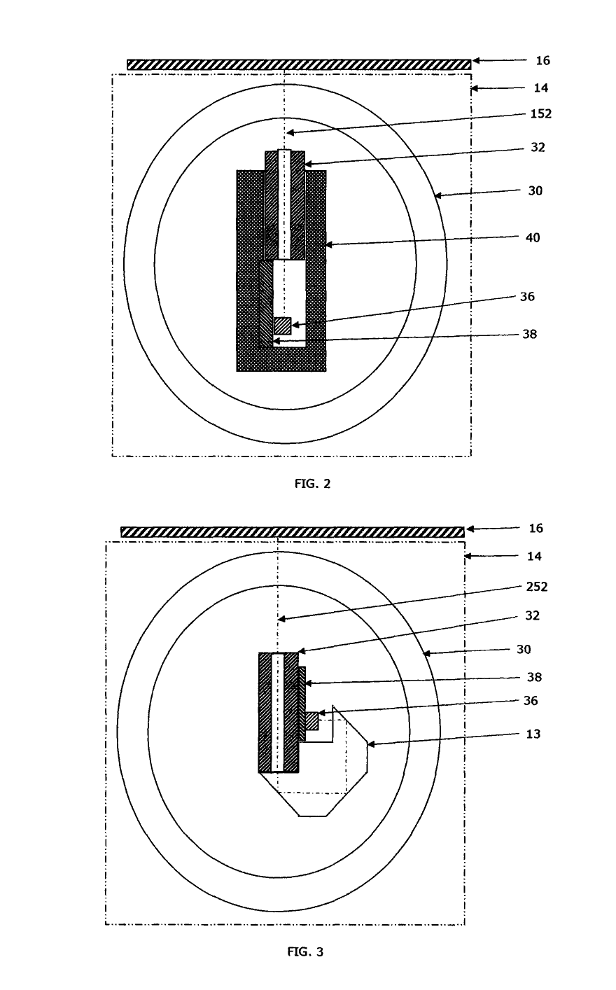

Refer to FIG. 3, which shows the cross section of an optical system in which an embodiment of the present invention is incorporated utilizing an optical prism 134 with more than two reflections. In this figure, the housing is not shown and can be eliminated or reduced if the optical prism 134 is silver coated and opaque except at the interfaces with the lens array 32 and the linear sensor array 36. The optical path is designated by optical path centerline 252. In this embodiment, light from the transparent media 16 passes through the rotating optical platen 30 and is captured by the lens array 32, reflects three times inside the optical prism 134 and is focused onto the linear sensor array 36.

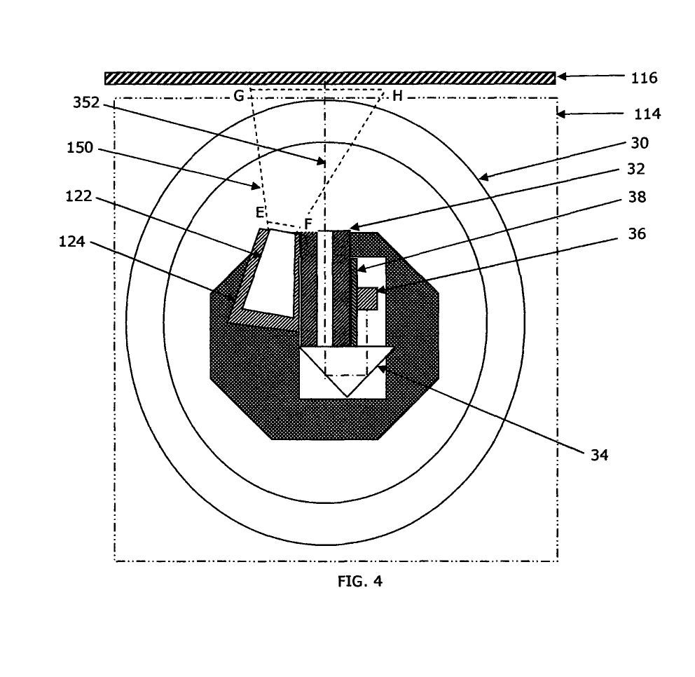

Refer to FIG. 4, which illustrates an embodiment of the present invention where both the illumination and optical subsystems are contained within a single rotating optical platen 30. This embodiment is used for scanning opaque documents when the documents are illuminated from the same side as where the optical module is located. The optical module 114 contains all the components of the previous optical module 14 shown in FIG. 1 but also contains illumination components consisting of a light source 122 and a reflector 124. FIG. 4 shows the illumination pattern and the optical path of the optical module 114 relative to the media 116. Polygon 150 depicts the illuminated space between the light source 122 and the media 116. Light exits the light source 122 along line E-F and illuminates the reflective media 116 primarily along line G-H with peak illumination occurring at the middle of line G-H. Light scattered from the media 116 passes through the rotating optical platen 30 and is captured and focused on the linear sensor array 36 by the lens array 32 and the optical element 34. Optical path centerline 352 depicts the optical path from the media 116 to the linear sensor array 36. The linear sensor array 36 converts the light into electronic charge that is proportional to the amount of light on each pixel in the array. The electronic charge can be accumulated and subsequently readout by the external electronics as a voltage.

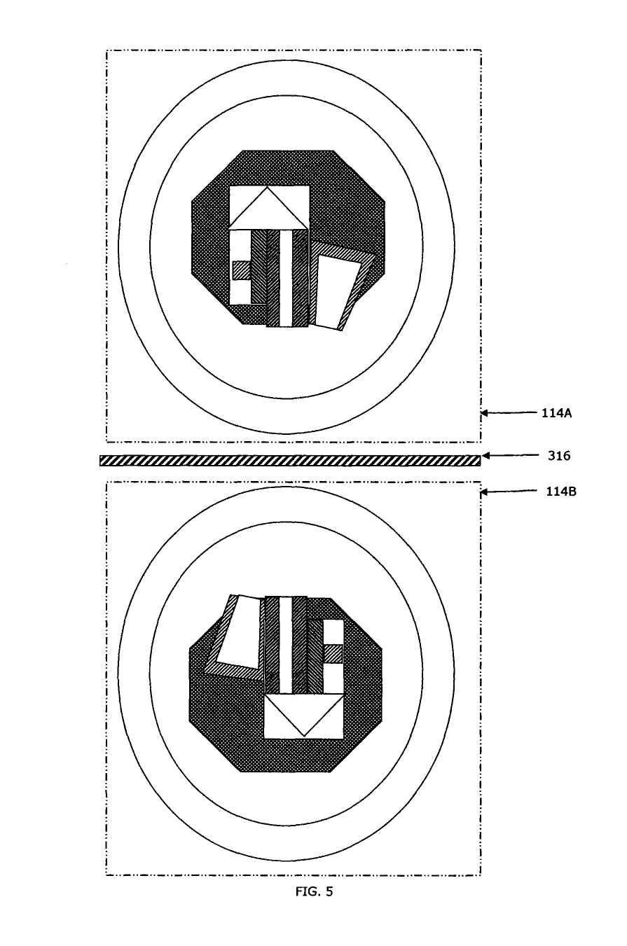

Refer to FIG. 5, which illustrates an embodiment of the invention where two optical modules, upper optical module 114A and lower optical module 114B are utilized to provide multiple scanning capabilities for media 216 that is either transparent or opaque. Illumination can be provided by either upper optical module 114A or lower optical module 114B dependent on whether variable media is transparent or opaque. If the media 216 is transparent, upper optical module 114A provides backside illumination while lower optical module 114B is used for image acquisition. If media 216 is opaque, upper optical module 114A scans the upper side of the media 216 and the lower optical module 114B scans the lower side of the media 216. The modules scan simultaneously or sequentially depending on the capabilities of the imaging system.

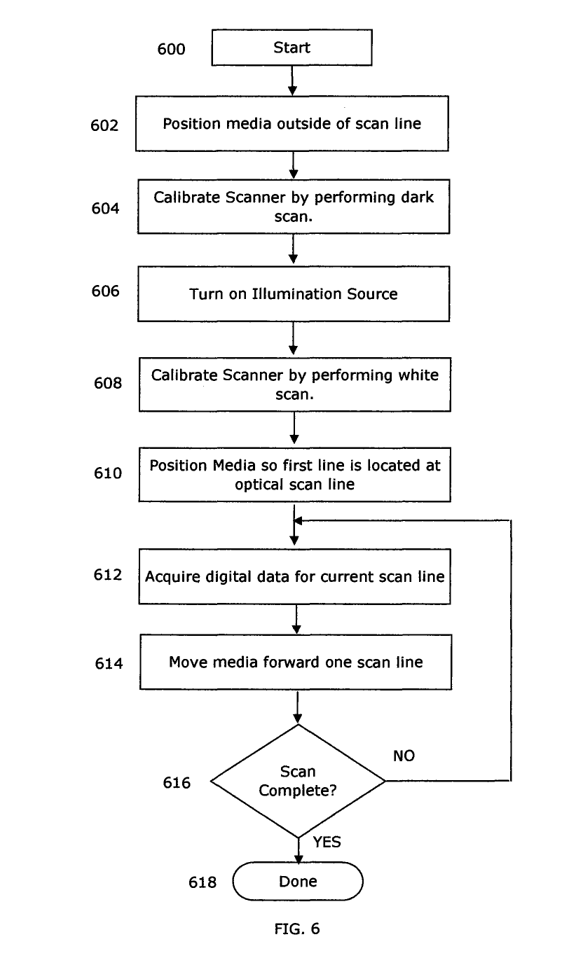

Refer to FIG. 6, which is a flowchart that illustrates a method of using the optical system in which an embodiment of the present invention is incorporated. The method starts with initiation of the scan in step 600. In step 602, the media is position to be outside of the scan line to allow calibration of the scan system in steps 604 through 608. For calibration, the illumination is turned off for step 604, which is the dark calibration. The dark calibration measures data in the absence of illumination to compensate for sensor variation. Illumination is turned on in step 606. Then white calibration is performed in step 608 to measure variation in the illumination and optical system. The dark and white calibration data can be used by the system to remove system variations and improve the quality of the scan. The media is moved into the imaging path in step 610. Step 612 acquires data for the current scan line and then the media is advanced forward by one line in step 614. Step 616 determines if the scan is complete. The scan can consist of a predetermined number of scan lines or the system can use other methods to determine when the scan is complete. For instance absence of media can be determined by independent sensors or by examining the scan data for the absence of media. If the scan is not complete, step 612 is executed to acquire another scan line. When the system determines the scan is complete the sequence moves from step 616 to step 618 and the method is complete.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An imaging system for acquiring images from media, comprising:
an optical module for generating a scanned image of a media object, the optical module comprising:
a scanning mechanism; and
a tubular optical platen that rotates about the scanning mechanism.

2. The imaging system for acquiring images from media of claim 1, the scanning mechanism comprising:
a light source;
a reflector for reflecting light toward the media; and
an imaging assembly.

3. The imaging system for acquiring images from media of claim 2, the imaging assembly comprising:
a linear sensor array for capturing an image of the media;
a lens array for creating the image of the media on the linear sensor array;
an interconnect circuit for controlling and acquiring an output signal from the linear sensor array; and
a housing for containing and aligning components of the imaging assembly.

4. The imaging system for acquiring images from media of claim 3, the imaging assembly further comprising:
an optical element for reducing imaging assembly's size.

5. The imaging system for acquiring images from media of claim 3, further comprising:
a control system for interfacing the imaging system to external components or storage.

6. The imaging system for acquiring images from media of claim 3, the linear sensor array comprising charge coupled device or complimentary metal oxide semiconductor technology.

7. The imaging system for acquiring images from media of claim 5, the control system comprising electronics, firmware, software, electromechanical components, or a combination of these.

8. The imaging system for acquiring images from media of claim 4, the optical component comprising an optical prism or a plurality of mirrors.

9. The imaging system for acquiring images from media of claim 3, the lens array comprising a unity magnification lens array.

10. An imaging system for acquiring images from media comprising:
an illumination system for illuminating the media; and
an optical module for capturing images of the media, the optical module comprising:
an imaging assembly; and
a rotating optical platen that rotates around the imaging assembly for accurately locating the media in an optimal focus plane.

11. The imaging system for acquiring images from media of claim 10, the illumination system comprising:
a light source;
a reflector for reflecting light toward the media.

12. The imaging system for acquiring images from media of claim 11, the illumination system further comprising:
a tubular diffusion platen for diffusing light from the light source.

13. The imaging system for acquiring images from media of claim 10, the imaging assembly comprising:
a linear sensor array for capturing an image of the media;
a lens array for creating the image of the media on the linear sensor array;
an interconnect circuit for controlling and acquiring an output signal from the linear sensor array; and
a housing for containing and aligning components of the imaging assembly.

14. The imaging system for acquiring images from media of claim 13, the imaging assembly further comprising:
an optical element for reducing imaging assembly's size.

15. The imaging system for acquiring images from media of claim 10, further comprising:
a control system for interfacing the imaging system to external components or storage.

16. The imaging system for acquiring images from media of claim 13, the linear sensor array comprising charge coupled device or complimentary metal oxide semiconductor technology.

17. The imaging system for acquiring images from media of claim 15, the control system comprising electronics, firmware, software, electromechanical components, or a combination of these.

18. The imaging system for acquiring images from media of claim 14, the optical component comprising an optical prism or a plurality of mirrors.

19. The imaging system for acquiring images from media of claim 13, the lens array comprising a unity magnification lens array.

20. An imaging system for acquiring images from media comprising:
an illumination system, the illumination system comprising:
a light source; and
a reflector for reflecting light toward the media; and
an optical module, the optical module comprising:
an imaging assembly; and
a rotating optical platen that rotates around the imaging assembly for accurately locating the media in an optimal focus plane.

21. The imaging system for acquiring images from media of claim 20, the illumination system further comprising:
a tubular diffusion platen for diffusing light from the light source.

22. The imaging system for acquiring images from media of claim 20, the imaging assembly comprising:
a linear sensor array for capturing an image of the media;
a lens array for creating the image of the media on the linear sensor array;
an interconnect circuit for controlling and acquiring an output signal from the linear sensor array; and
a housing for containing and aligning components of the imaging assembly.

23. The imaging system for acquiring images from media of claim 22, the imaging assembly further comprising:
an optical element for reducing imaging assembly's size.

24. The imaging system for acquiring images from media of claim 20, further comprising:
a control system for interfacing the imaging system to external components or storage.

25. The imaging system for acquiring images from media of claim 22, the linear sensor array comprising charge coupled device or complimentary metal oxide semiconductor technology.

26. The imaging system for acquiring images from media of claim 24, the control system comprising electronics, firmware, software, electromechanical components, or a combination of these.

27. The imaging system for acquiring images from media of claim 23, the optical component comprising an optical prism or a plurality of mirrors.

28. The imaging system for acquiring images from media of claim 22, the lens array comprising a unity magnification lens array.
